(19) United States
(12) Patent Application Publication
(10) Pub. No.: US 2016/0075295 A1
(43) Pub. Date: Mar. 17, 2016

(54) PRESSURE SIDE IMPACT SENSOR FOR VEHICLE AND STRUCTURE FOR MOUNTING THE SAME

(71) Applicant: HYUNDAI MOBIS CO., LTD., Seoul (KR)

(72) Inventors: Byeong Yeol KIM, Yongin (KR); Min Ho CHO, Yongin (KR); Nam Wook KIM, Yongin (KR); Man Chul JEON, Yongin (KR)

(21) Appl. No.: 14/528,968

(22) Filed: Oct. 30, 2014

(30) Foreign Application Priority Data
Sep. 16, 2014 (KR) 10-2014-0122773

(51) Int. Cl. B60R 21/0136

(52) U.S. Cl. CPC B60R 21/0136

(57) ABSTRACT

A pressure side impact sensor for a vehicle according to an exemplary embodiment of the present invention includes: a housing which has a connector; a middle cover which is connected with the housing, and has a flow path for transmitting air; an air pressure sensor which is positioned between the housing and the middle cover, and detects air pressure in a vehicle; and a cover which is connected with the middle cover, in which the middle cover has a locking hole, and the cover further includes a guide locking portion which is movable inward and outward from the cover, and coupled to the locking hole.

### CROSS-REFERENCE TO RELATED APPLICATIONS

This application claims priority to and the benefit of Korean Patent Application No. 10-2014-0122773 filed in the Korean Intellectual Property Office on Sep. 16, 2014, the entire contents of which are incorporated herein by reference.

### TECHNICAL FIELD

The present invention relates to a pressure side impact sensor for a vehicle. More particularly, the present invention relates to a pressure side impact sensor for a vehicle in which structures for preventing rotational motion and separation are integrated into a single constituent element.

### BACKGROUND ART

A side airbag is installed in a vehicle in order to protect a driver. At the time of a broadside collision of a vehicle, an output signal from a side impact sensor, which is installed at a side of the vehicle, is input to an airbag control unit (ACU), and deployment of the side airbag is controlled by the ACU.

Recently, in order to sense whether a broadside collision occurs, a pressure side impact sensor (PSIS) is mounted at a side portion of the vehicle.

For example, the PSIS is mainly mounted in doors at a side of a driver seat and a front passenger seat. At the time of a broadside collision, the PSIS serves to sense a pressure change, which instantaneously occurs in the door due to deformation of the door, and transmit the sensed pressure change to the ACU.

An AK-LV 29 standard is a standard regarding the PSIS, which is regulated by European vehicle OEM, and defines a connector specification, a communication method, and a mounting method (a method of mounting the PSIS by rotating the PSIS by 60 degrees with one hand) as a standard.

FIG. 1 is a view illustrating a front side of the pressure side impact sensor in the related art, and FIG. 2 is a view illustrating a rear side of the pressure side impact sensor in the related art.

Referring to FIGS. 1 and 2, a pressure side impact sensor 1 in the related art has a release prevention portion 2, a rotation direction fixing portion 3, a handle 4, and a connector portion 5 at a front side thereof, and has an air flow path 6, and a sealing unit 7 at a rear side thereof.

The PSIS of the AK-LV standard is mounted by being rotated using one hand, and as a result, convenience of mounting the PSIS is improved by a structure of two handles 4. The structure of the handle 4 allows larger moment to be transmitted when the PSIS is rotated. Since the PSIS needs not to be released by a durable condition or vibration of the vehicle after the PSIS is completely mounted, the PSIS has the release prevention portion 2.

However, there is a problem in that the PSIS in the related art has a complicated structure for assembling a plurality of components. For example, components such as the rotation direction fixing portion 3 for restricting rotation direction motion, and the release prevention portion 2 for preventing separation of the components are additionally required, and as a result, the structure becomes complicated.

### LITERATURE OF RELATED ART

Korean Patent No. 10-1405762

### SUMMARY OF THE INVENTION

The present invention has been made in an effort to provide a pressure side impact sensor in which structures for preventing rotational motion and separation are integrated into a single constituent element.

An exemplary embodiment of the present invention provides a pressure side impact sensor for a vehicle, including: a housing which has a connector; a middle cover which is connected with the housing, and has a flow path for transmitting air; an air pressure sensor which is positioned between the housing and the middle cover, and detects air pressure in a vehicle; and a cover which is connected with the middle cover, in which the middle cover has a locking hole, and the cover further includes a guide locking portion which is movable inward and outward from the cover, and coupled to the locking hole.

The pressure side impact sensor may further include a pressure sensor sealing unit which is positioned between the middle cover and the air pressure sensor.

The cover may further include a mounting guide which restricts motion of the middle cover.

The mounting guide may have a curved surface.

Two mounting guides may be formed to face each other.

One end of the mounting guide may protrude to control the rotation of the middle cover.

The guide locking portion may be formed as a hook.

One surface of the guide locking portion may be inclinedly formed.

When the guide locking portion is coupled to a vehicle body, the guide locking portion may be decoupled from the locking hole while the inclined surface formed on the guide locking portion is pushed by the vehicle body.

A plurality of guide locking portions may be formed to face each other, and a plurality of locking holes may be provided to be coupled to the guide locking portions.

Another exemplary embodiment of the present invention provides a structure for mounting a pressure side impact sensor for a vehicle, the pressure side impact sensor including: a housing; a middle cover which is connected with the housing; an air pressure sensor which is positioned between the housing and the middle cover; and a cover which is connected with the middle cover, in which the middle cover has a locking hole, and the cover further includes a guide locking portion which is movable inward and outward from the cover, and coupled to the locking hole, in which when inserted into a vehicle body through hole formed in a vehicle body of the vehicle, the guide locking portion is pushed by the vehicle body and moved inward such that a fixed state with the locking hole is released, and the middle cover is rotated to be fixed to the vehicle body.

The pressure side impact sensor for a vehicle according to the exemplary embodiment of the present invention may simplify a structure by integrating structures for preventing rotational motion and separation.

The structure may be simplified by forming the locking structure on the guide locking portion of the cover.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a front side of a pressure side impact sensor in the related art.

FIG. 2 is a view illustrating a rear side of the pressure side impact sensor in the related art.

FIG. 3 is an exploded perspective view of a pressure side impact sensor for a vehicle according to an exemplary embodiment of the present invention.

FIG. 4 is a view illustrating a coupled state of FIG. 3. FIG. 5 is a view illustrating a coupled state of a middle cover and a cover that are constituent elements of the present invention.

FIG. 6 is a view illustrating a state before a vehicle body and a coupling member are coupled to each other.

FIG. 7 is a view illustrating an operation of mounting the coupling member of FIG. 6 to the vehicle body.

FIG. 8 is a front perspective view of the middle cover that is a constituent element of the present invention.

FIG. 9 is a rear perspective view of FIG. 8.

FIG. 10 is a view illustrating a coupling structure before the middle cover and the cover, which are constituent elements of the present invention, are coupled to each other.

FIG. 11 is a view illustrating a coupling structure after the middle cover and the cover of FIG. 10 are coupled to each other.

FIG. 12 is a view illustrating a structure of the cover that is a constituent element of the present invention.

FIG. 13 is a cross-sectional view illustrating an internal structure when the pressure side impact sensor for a vehicle according to the exemplary embodiment of the present invention is coupled to the vehicle body.

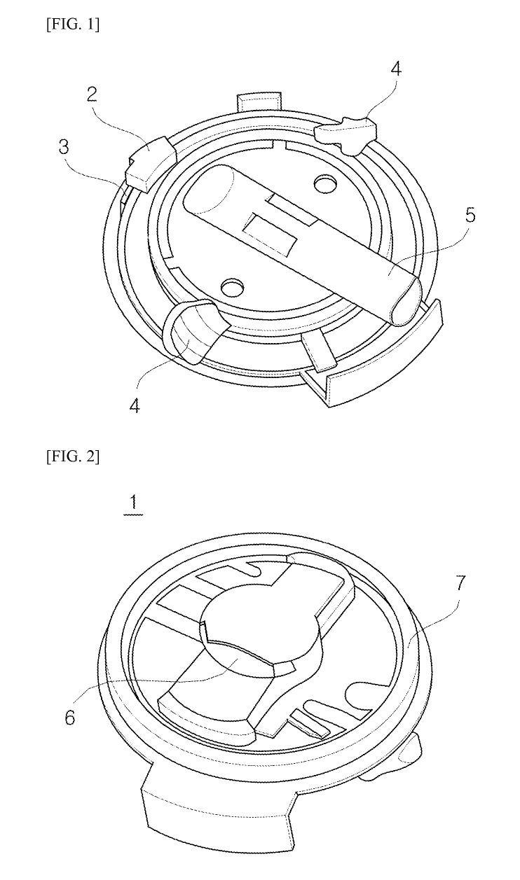

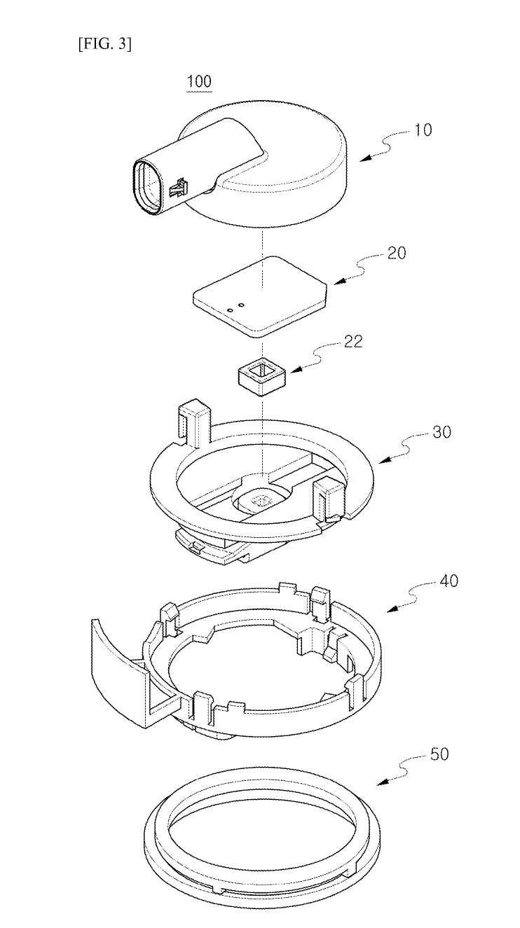

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a pressure side impact sensor for a vehicle according to an exemplary embodiment of the present invention will be described in detail with reference to the accompanying drawings. First, in denoting reference numerals to constituent elements of respective drawings, it should be noted that the same elements will be designated by the same reference numerals although they are shown in different drawings. Hereinafter, an exemplary embodiment of the present invention will be described, but, of course, it is obvious that the technical spirit of the present invention is not restricted or limited thereto, but the exemplary embodiment of the present invention may be modified by a person with ordinary skill in the art to be variously carried out.

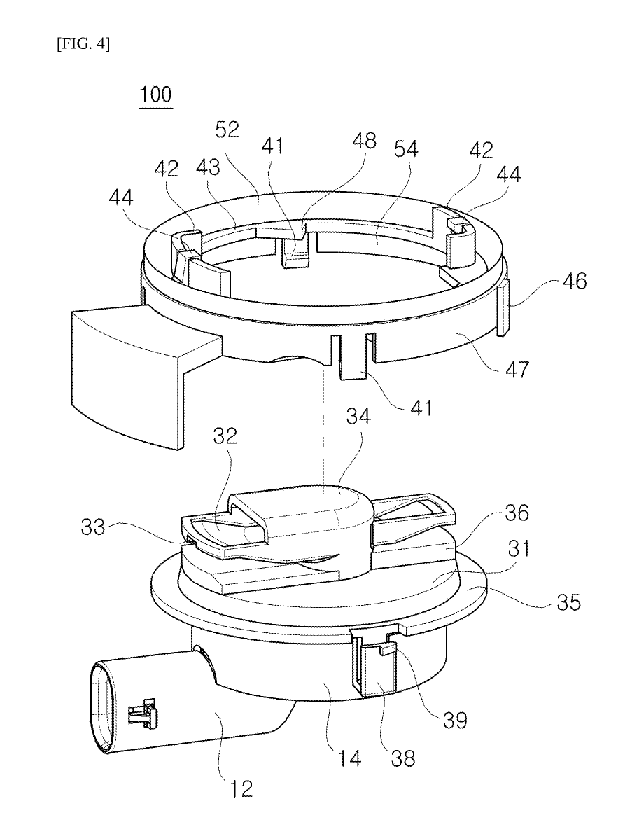

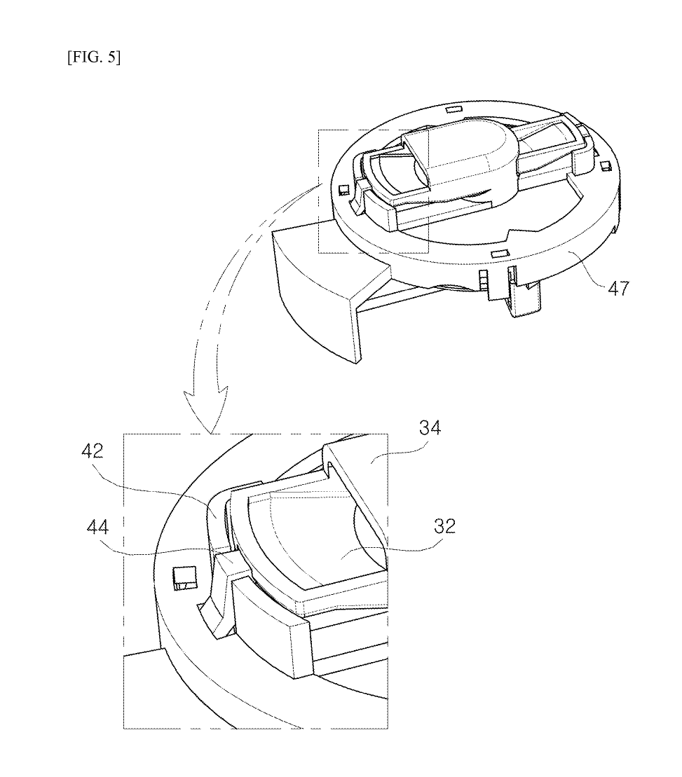

FIG. 3 is an exploded perspective view of a pressure side impact sensor for a vehicle according to an exemplary embodiment of the present invention, and FIG. 4 is a view illustrating a coupled state of the pressure side impact sensor for a vehicle according to the exemplary embodiment of the present invention (FIG. 4 is a view illustrating a coupled state of constituent elements of FIG. 3 when viewed from a rear side).

A pressure side impact sensor 100 for a vehicle according to the exemplary embodiment of the present invention may include a housing 10 which has a connector 12, a middle cover 30 which has a flow path 32 for transmitting air, an air pressure sensor 20 which detects air pressure in an impact sensor, a cover 40, and a sealing unit 50 which is mounted to the cover 40.

In the exemplary embodiment, the housing 10 may be formed to have a cylindrical shape, and may have the connector 12 at an upper portion thereof. The connector 12 supplies electric power, and is formed to protrude at one side of the housing 10. The position and the shape of the connector 12 are not limited, and various modifications may be implemented.

The middle cover 30 is connected with the housing 10, and has the flow path 32 for transmitting air.

An upper portion of the middle cover 30 has an annular supporting portion 35, a protruding plate 31 which protrudes to one side of the supporting portion 35, and a middle cover base 36 which is fixed to the protruding plate 31, and serves as a fixing side that is fixed to a vehicle body 60 when the pressure side impact sensor 100 is mounted in the vehicle.

The flow path 32, which transmits air, may be formed at one side of an upper portion of a middle cover key hole 34, and a locking hole 33 may be formed at a lower side of the middle cover key hole 34.

The locking hole 33 is formed at a lower side of the middle cover key hole 34, and coupled to a guide locking portion formed on the cover 40. In the exemplary embodiment, the locking hole 33 may be formed as a recessed portion having a square column shape, and the locking holes 33 are provided at both sides of the middle cover key hole 34. The shape of the locking hole 33 may be variously modified and implemented in accordance with a shape of the guide locking portion.

A hook portion 38, which protrudes in a downward direction of the supporting portion 35, may be provided at one side of the supporting portion 35. The hook portion 38 has elastic force so that the hook portion 38 may be deformed when external force is applied to the hook portion 38, and may be restored to an original shape when the external force is eliminated. In the exemplary embodiment, the hook portion 38 may be formed in a “ [symbol] ”-shaped cross-sectional shape. One end of the hook portion 38 is connected with the supporting portion 35, and the other end thereof is opened. The hook portion 38 having the aforementioned shape may be contracted in a direction in which external force is applied, and may be restored to have the “ [symbol] ” shape when the external force is eliminated.

A release prevention projection 39 is provided at open end of the hook portion 38, and coupled to a cover protruding portion 46 formed on the cover 40 so as to restrict rotation of the coupled middle cover 30.

In the exemplary embodiment, the release prevention projection 39 may be configured to have a wedge shape. When the release prevention projection 39 is coupled to the cover protruding portion 46, the cover protruding portion 46 may be moved along a wedge surface. In this case, the hook portion 38 is contracted inward, and after the cover protruding portion 46 passes over the release prevention projection 39, the release prevention projection 39 is restored to an original position by elasticity of the hook portion 38. The cover protruding portion 46, which have passed over the release prevention projection 39, is caught by an end of the wedge, such that the rotation of the middle cover 30 is restricted.

The air pressure sensor 20 is positioned between the housing 10 and the middle cover 30, and detects air pressure at the time of a broadside collision. In the exemplary embodiment, a PCB may be used for the air pressure sensor 20. The air pressure sensor 20 measures air pressure transmitted through the flow path 32, and whether a broadside collision of the vehicle occurs is determined depending on a change in air pressure.

A pressure sensor sealing portion 22 is positioned between the air pressure sensor 20 and the middle cover 30, and seals the interior of the sensor, thereby maintaining air pressure inside the air pressure sensor 20.

The cover 40 is formed by coupling an outside portion 47 and an inside portion 43, and connected with the middle cover 30.

The outside portion 47 accommodates the supporting portion 35 of the middle cover 30, and may have a circular annular shape having a predetermined height. A cover protruding portion 46 and a coupling hook 41 may be installed on an outer circumferential surface of the outside portion 47.

The cover protruding portion 46 is connected to the outside portion 47, and coupled to the release prevention projection 39 formed on the middle cover 30, thereby restricting the rotation of the middle cover 30. In the exemplary embodiment, the cover protruding portion 46 may have a square column shape, and may have a height that is greater than a height of the outside portion 47 of the cover 40. A plurality of cover protruding portions 46 may be provided on the outside portion 47 so as to face each other.

The coupling hook 41 allows the middle cover 30 to be easily coupled. In the exemplary embodiment, the coupling hook 41 is formed to be longer than a bottom surface of the outside portion 47, and left and right sides of the coupling hook 41 are cut out, such that the coupling hook 41 may be moved forward and rearward when coupled to the middle cover 30. A projection is formed toward the inside of the cover 40, and controls separation of the middle cover 30 when coupled to the middle cover 30.

The inside portion 43 may be provided to have a circular annular shape having a height that is smaller than the height of the outside portion 47. When coupled to the middle cover 30, the middle cover key hole 34, which is provided in the middle cover 30, is positioned in an inner hole formed in the inside portion 43. A mounting guide 42, a guide locking portion 44, a through hole 45, and a stopper 48 may be provided at the inside portion 43.

The mounting guide 42 is formed at a place where the middle cover key hole 34 is positioned when coupled to the middle cover 30. The mounting guide 42 protrudes from the inside portion 43, and has a curved shape in order to facilitate the rotation of the middle cover 30. In the exemplary embodiment, one side of the mounting guide 42 is formed to protrude in an inward direction in which the middle cover is mounted, and may restrict the middle cover 30 so that the middle cover 30 may be rotated only in one direction. A plurality of mounting guides 42 may be provided on the inside portion 43 so as to face each other, and may be formed integrally with the inside portion.

The guide locking portion 44 may be formed at a center of the mounting guide 42, and may be coupled to the locking hole 33 formed in the middle cover 30. In the exemplary embodiment, left and right sides of the guide locking portion 44 are cut out, and the guide locking portion 44 may be moved inward and outward from the cover 40. The guide locking portion 44 has a cross section having a nearly vertical inner surface, and an end of the guide locking portion 44 is coupled to the locking hole 33, thereby fixing the middle cover 30. An outer surface of the guide locking portion 44 is formed to be inclined, and the guide locking portion 44 may be moved inward and outward from the cover 40 when coupled to the vehicle body 60. A mounting position or a shape of the guide locking portion 44 may be variously modified and implemented in order to perform the aforementioned functions.

The stopper 48 may be provided to protrude in an inward direction from the inside portion 43, and restrict a rotation angle when the middle cover 30 is rotated. In the exemplary embodiment, a plurality of stoppers 48 may be provided on the inside portion 43 so as to face each other, thereby restricting the rotation of the middle cover 30. The stopper 48 may be separately mounted on the inside portion 43, or may be formed integrally with the inside portion 43. A position of the stopper 48 may be adjusted in accordance with a rotation angle at which the middle cover 30 is rotated, and a shape of the stopper 48 may be modified and implemented in various shapes for controlling the middle cover 30.

A plurality of through holes 45 is formed in the inside portion 43, and enables double injection molding when coupled to the sealing unit 50. In the exemplary embodiment, a plurality of through holes 45 is formed to face each other, and the inside portion 43, an upper seal 52, and a lower seal 54 may be integrally coupled through the through holes 45.

The sealing unit 50 is divided into the upper seal 52 and the lower seal 54, and the upper seal 52 and the lower seal 54 may be coupled to upper and lower portions of the cover 40, respectively, or may be integrally formed through the through hole 45 formed in the cover 40.

FIG. 5 is a view illustrating a coupled state of the middle cover and the cover that are constituent elements of the present invention. Referring to FIG. 5, the middle cover 30 is inserted into the cover 40 along the mounting guide 42. In this case, the guide locking portion 44 is moved outward by being pushed by the middle cover key hole 34, external force, which is applied by the middle cover key hole 34, is eliminated by the locking hole 33 formed in the middle cover key hole 34, and the guide locking portion 44 is restored to an original shape by elastic force, and coupled to the locking hole 33.

In the exemplary embodiment, the aforementioned operation is performed at both sides of the middle cover key hole 34 by the plurality of locking holes 33, and the rotation of the middle cover 30 may be prevented by coupling the locking hole 33 and the guide locking portion 44.

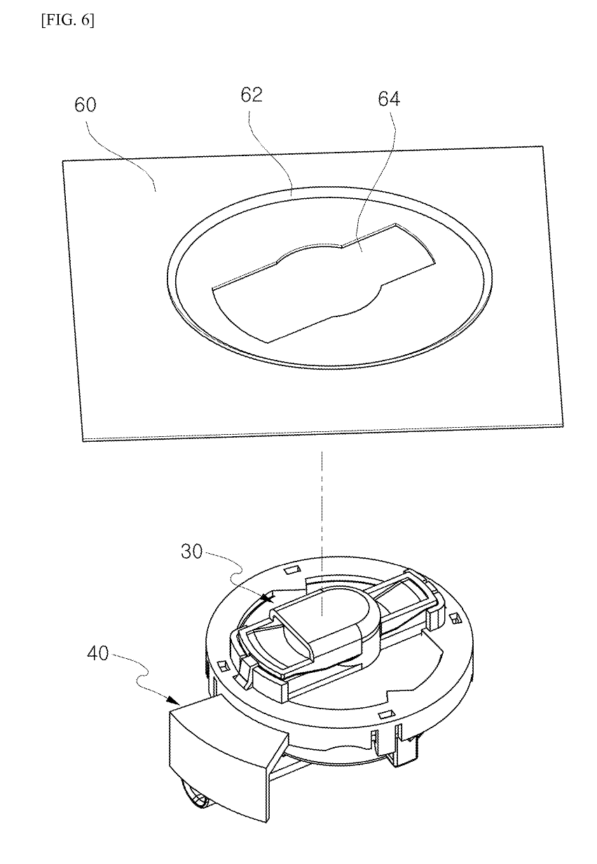

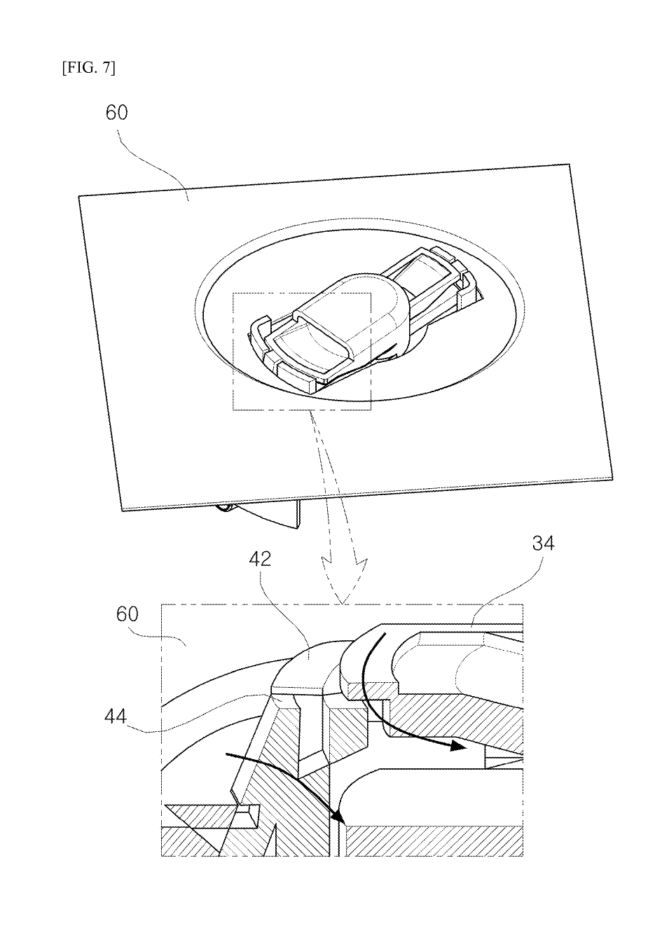

FIG. 6 is a view illustrating a state before the vehicle body and the coupling member are coupled to each other, and FIG. 7 is a view illustrating an operation of mounting the coupling member, which has the middle cover and the cover coupled thereto, to the vehicle body.

Referring to FIGS. 6 and 7, the vehicle body 60 includes a vehicle body coupling portion 62 and a vehicle body through hole 64.

The middle cover key hole 34 provided in the middle cover 30 is inserted into the vehicle body through hole 64. In the exemplary embodiment, the vehicle body through hole 64 is formed in a cross-sectional shape of the middle cover key hole 34, and may be variously modified and implemented in accordance with the cross-sectional shape of the middle cover key hole 34.

The vehicle body coupling portion 62 is a place where the middle cover key hole 30 is rotated. In the exemplary embodiment, the vehicle body coupling portion 62 may be provided to be lower than the vehicle body 60, and may have a circular shape. A size of the vehicle body coupling portion 62 may be variously modified and implemented in accordance with a diameter of the middle cover key hole 34. When the coupling member having the middle cover 30 and the cover 40 coupled thereto is mounted to the vehicle body 60, the outer surface of the guide locking portion 44, which is inclinedly formed, is pushed by the vehicle body 60, such that external force is applied to the inside of the cover 40. The applied external force pushes the guide locking portion 44 inward, thereby releasing the restricted state in which the guide locking portion 44 is caught by the locking hole 33. In this case, the restriction of the rotation applied to the middle cover 30 is released, and the pressure side impact sensor is mounted to the vehicle body 60 by rotating the middle cover 30.

The vehicle body 60 may be inserted between the middle cover key hole 34 and the middle cover base 36 by rotating the middle cover 30, and the middle cover 30 may be fixed to the vehicle body 60 by frictional force of the vehicle body 60.

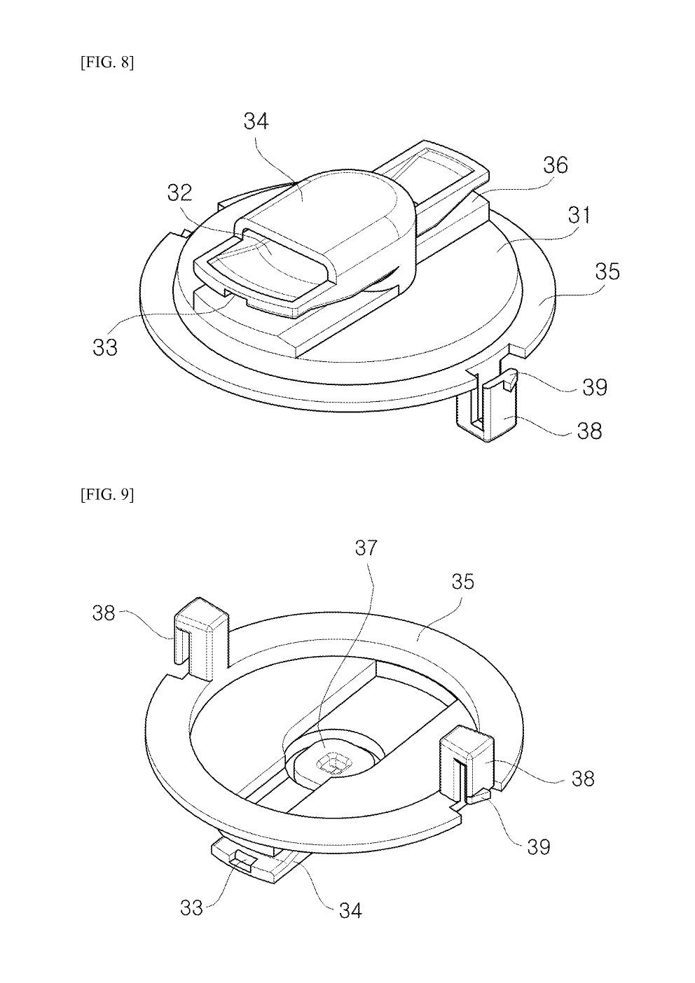

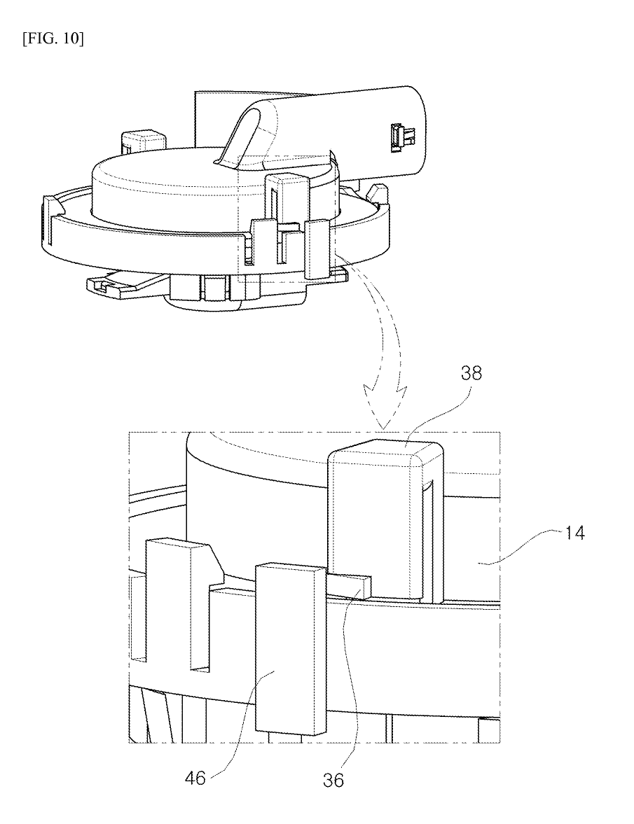

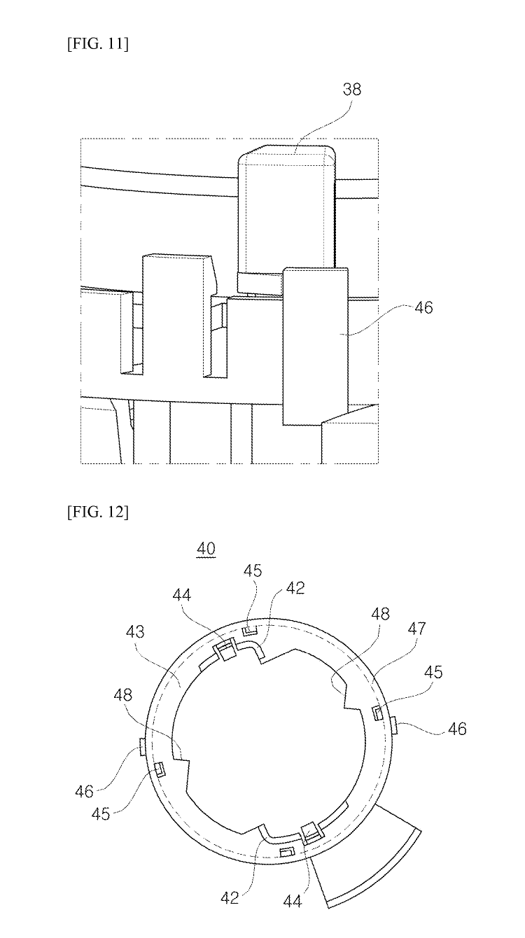

FIG. 8 is a front perspective view of the middle cover that is a constituent element of the present invention, FIG. 9 is a rear perspective view of the middle cover, FIG. 10 is a view illustrating a coupling structure before the middle cover and the cover, which are constituent elements of the present invention, are coupled to each other, and FIG. 11 is a view illustrating a coupling structure after the middle cover and the cover are coupled to each other.

Referring to FIGS. 8 to 11, when the cover 40 and the middle cover 30 are coupled to each other, the hook provided on the cover 40 and the supporting portion 35 of the middle cover 30 are coupled to control motion in an upward and downward direction.

The cover protruding portion 46 provided on the cover 40 may be coupled to the release prevention projection 39 formed on the middle cover 30, thereby restricting the rotation of the middle cover 30.

When the middle cover 30 is rotated, the release prevention projection 39, which is inclinedly formed, is pushed downward into the cover protruding portion 46 provided on the cover 40, and the hook portion 38 is pushed into the cover protruding portion 46 by an action of external force caused by the cover protruding portion 46. At the moment when the release prevention projection 39 passes over the cover protruding portion 46, the applied external force is eliminated, and the hook portion 38 is restored to an original state, such that the cover protruding portion 46 controls the rotation of the middle cover 30 in an opposite direction.

When a worker pushes the release prevention projection 39 from the outside to the inside, the hook portion 38 is deformed, and a fastened state between the release prevention projection 39 and the cover protruding portion 46 may be released, such that the sensor may be attached and detached.

FIG. 12 is a view illustrating a structure of the cover that is a constituent element of the present invention.

Referring to FIG. 12, the stopper 48, which controls the rotation of the middle cover 30, may be provided on the inside portion 43 of the cover 40. In the exemplary embodiment, the stopper 48 comes into contact with the middle cover base 36 provided on the middle cover 30 so as to restrict the rotation of the middle cover 30, and a plurality of stoppers 48 may be provided on the inside portion 43 so as to face each other. The stopper 48 may be formed integrally with the inside portion 43 so as to protrude from the inside portion 43 of the cover 40, and may adjust a rotation amount of the middle cover 30 by measuring an angle from the guide locking portion 44. The shape or the form of the stopper 48 may be modified and implemented in various forms.

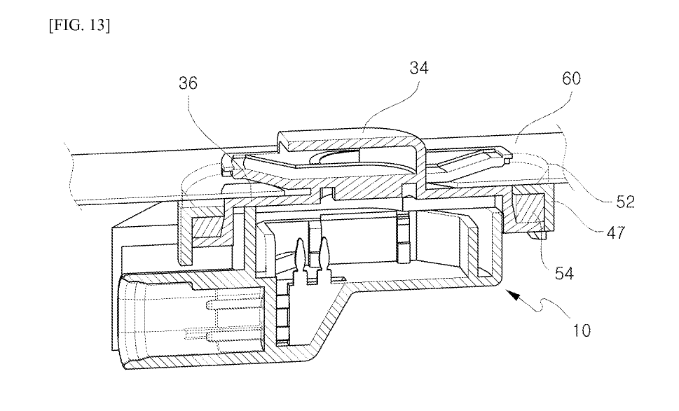

FIG. 13 is a cross-sectional view illustrating an internal structure when the pressure side impact sensor for a vehicle according to the exemplary embodiment of the present invention is coupled to the vehicle body.

Referring to FIG. 13, the sealing unit 50 may include the upper seal 52 and the lower seal 54. The upper seal 52 may be provided at an upper side of the inside portion 43 of the cover 40, and the lower seal 54 may be provided at a lower side of the inside portion 43 of the cover 40. The sealing unit 50 may be integrally formed by injection molding using the through hole 45 formed in the cover 40, and in a case in which the sealing unit 50 is integrally formed by injection molding, coupling performance with the cover 40 may be improved.

Rubber, silicone, or the like may be used for the sealing unit 50, and the material of the sealing unit 50 may be modified and implemented as various materials in order to seal the interior of the vehicle sensor.

The sealing unit 50 may prevent a connection when coupled to the vehicle body 60, and may solve problems with durability due to vibration. Since the same force is applied to the upper seal 52 and the lower seal 54, it is possible to prevent a problem in that a load is excessively concentrated onto only one side, and air leaks at the other side.

As described above, the pressure side impact sensor for a vehicle according to the exemplary embodiment of the present invention may simplify a structure by integrating structures for preventing rotational motion and separation.

The structure may be simplified by forming the locking structure on the guide locking portion of the cover.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A pressure side impact sensor for a vehicle, comprising:
a housing;
a middle cover which is connected with the housing;
an air pressure sensor which is positioned between the housing and the middle cover; and
a cover which is connected with the middle cover,
wherein the middle cover has a locking hole, and the cover further includes a guide locking portion which is movable inward and outward from the cover, and coupled to the locking hole.

2. The pressure side impact sensor of claim 1, further comprising:
a pressure sensor sealing unit which is positioned between the middle cover and the air pressure sensor.

3. The pressure side impact sensor of claim 1, wherein the cover further includes a mounting guide which restricts motion of the middle cover.

4. The pressure side impact sensor of claim 3, wherein the mounting guide has a curved surface.

5. The pressure side impact sensor of claim 4, wherein two mounting guides are formed to face each other.

6. The pressure side impact sensor of claim 4, wherein one end of the mounting guide protrudes to control the rotation of the middle cover.

7. The pressure side impact sensor of claim 1, wherein the guide locking portion is formed as a hook.

8. The pressure side impact sensor of claim 7, wherein one surface of the guide locking portion is inclinedly formed.

9. The pressure side impact sensor of claim 8, wherein when the guide locking portion is coupled to a vehicle body, the guide locking portion is decoupled from the locking hole while the inclined surface formed on the guide locking portion is pushed by the vehicle body.

10. The pressure side impact sensor of claim 1, wherein a plurality of guide locking portions is formed to face each other, and a plurality of locking holes is provided to be coupled to the guide locking portions.

11. A structure for mounting a pressure side impact sensor for a vehicle, the pressure side impact sensor comprising: a housing; a middle cover which is connected with the housing; an air pressure sensor which is positioned between the housing and the middle cover; and a cover which is connected with the middle cover, wherein the middle cover has a locking hole, and the cover further includes a guide locking portion which is movable inward and outward from the cover, and coupled to the locking hole,
wherein when inserted into a vehicle body through hole formed in a vehicle body of the vehicle, the guide locking portion is pushed by the vehicle body and moved inward such that a fixed state with the locking hole is released, and the middle cover is rotated to be fixed to the vehicle body.
